(19) United States
(12) Patent Application Publication
(10) Pub. No.: US 2018/0225034 A1
(43) Pub. Date: Aug. 9, 2018

(54) System and Method For Generating a User Interface For Communicating With a Remote Device

(71) Applicant: ImageCraft Creations Inc., Palo Alto, CA (US)

(72) Inventors: Richard F. Man, Palo Alto, CA (US); Christina J. Willrich, Palo Alto, CA (US)

(21) Appl. No.: 15/892,403

(22) Filed: Feb. 8, 2018

Related U.S. Application Data
(60) Provisional application No. 62/456,894, filed on Feb. 9, 2017.

(51) Int. Cl. G06F 3/0484; G06F 3/0481

(52) U.S. Cl. CPC G06F 3/04847; G06F 3/0481

(57) ABSTRACT

A system and method for generating a user interface on a user device for communicating with a remote device is described. An appliance designer selects objects to be displayed in the user interface by making API calls, and from the API calls translation software on the appliance generates commands to software on an associated user device for the user device to generate and display the user interface and wirelessly transmits those commands to the user device. From the perspective of the designer, only selection of the objects is required, and the resulting user interface is platform independent. The translation software and user device software allow the user device to display the user interface without the designer needing to know any user device or user device operating system specific programming, or any wireless communication protocol details.

This application claims priority from Provisional Application No. 62/456,894, filed Feb. 9, 2017, which is incorporated by reference herein in its entirety.

### FIELD OF THE INVENTION

The present application relates generally to embedded devices and systems, and more specifically to creating user interfaces for communicating with such embedded devices and systems remotely.

### BACKGROUND

Embedded devices, which are typically “smart” devices that are part of a larger electrical or mechanical system, are rapidly becoming widespread. The circuitry that controls the operation of a household appliance, for example, a washer or dryer, is typically now an embedded device (it may also be called an embedded system). In addition, as wireless technology proliferates, more and more devices are being accessed and/or controlled remotely as the “Internet of Things” (or “IoT”) is developed.

Embedded devices typically contain a microcontroller, which is a small, integrated circuit that contains a processor or CPU (central processing unit), and may also contain peripheral systems such as clocks and timers, memory, buses (for example, a Universal Serial Bus or USB), etc. A microcontroller contains software, often referred to as “firmware,” which runs on the microcontroller and allows the microcontroller to operate the larger system in which the embedded device is located, such as the washer or dryer.

If user input is necessary or desirable in order to control the embedded device, a user interface may be provided through which a user can interact with the embedded device. Such an interface may include a means for the user to enter inputs, such as one or more buttons or dials, and now often includes a display screen. The display screen may, for example, allow a user to see the available functions of the embedded device, which typically correspond to the functions of the appliance of which the embedded device is a part. In some cases, the display screen may also allow the user to see the status or operating condition of the appliance.

Thus, a washer or dryer may include a display screen showing the various available control functions of an embedded controller which may, for example, correspond to the available cycles of the washer or dryer, such as “normal,” “permanent press,” etc., or to various settings such as time and temperature. The display screen may also show the current state of the washer or dryer, such as which cycle is being run, and its expected completion time.

However, incorporating a display screen creates an additional burden on the designer of the appliance. When a display screen is used, in addition to the firmware that allows the microcontroller to operate the appliance, additional software is needed to cause the display screen to display the various functions of the embedded device, and thus of the appliance, in a manner that a user can understand. Thus, a designer of a system or appliance containing an embedded system, such as the washer or dryer, must not only write or obtain the firmware for the microcontroller to control the system or appliance, but also the additional software needed to allow the microcontroller to display the appropriate information for a user on the display screen.

If the appliance is intended to be able to be accessed remotely from a variety of types of user devices, this problem is increased significantly, as now software to display a user interface must be written for each separate possible type of device, such as smartphones, tablets, computers, etc., and for each separate possible operating system for each type of device, such as iOS, Android, MacOS, Windows, etc. (and perhaps different versions of each operating system). In such situations, an appliance designer or manufacturer must be able to program a user interface in each of these environments.

In addition to this added software burden on a designer of an appliance with an embedded device, in some cases it may be necessary to limit the size of a display screen, or, in some cases, impractical to include a display screen on an appliance. Consider, for example, a “smart” wall plug, i.e., one that can function as a normal electrical outlet into which a user may plug a lamp or other electrical device, but is also programmable for one or more functions. For example, it may be desired to have the smart plug function as a timer, so as to turn on and off at certain times, or to adjust the level of power provided so as to provide the functionally of a “dimmer” light switch but without a physical switch.

In a traditional design, due to its limited size such a wall plug would be able to use only a very small display screen, such as a liquid crystal display (LCD) or light emitting diode (LED) screen, and a few push buttons, each of which might need to serve multiple purposes. A user might typically be required to follow a specific sequence of steps to, for example, set a time schedule, perhaps selecting a “set” mode and then cycling through a time display to select an “on” time, then cycling through the time display again to set an “off” time, etc. A separate, equally lengthy set of steps might be necessary to adjust the level of output of the smart plug, i.e., to perform the “dimmer” function. The process will be progressively more complicated as more advanced features are added.

This limitation on the size of a display screen provides one motivation to allow a user device having a larger display screen to remotely access an appliance, but as above creates the problem of having to perform multiple programming tasks to accommodate multiple platforms.

Still further, a designer of an appliance that is intended to be accessed wirelessly will have to select which of the available wireless technologies is to be used for such communication, and then to know and include the necessary hardware and program instructions to perform the wireless protocol(s) appropriate for the selected technology.

It would be desirable to have a platform-independent way for an appliance designer using an embedded device to simply create the software necessary to generate and display a user interface without needing to consider all of the possible device platforms in which such an interface might be displayed, or to consider the requirements of the wireless technology that is to be used to communicate with a user device.

### SUMMARY OF THE INVENTION

As described herein, a system and method for generating a user interface for communicating with a remote device is accomplished by allowing an appliance designer to select objects to be displayed in a user interface from a library of available objects by making API calls. From the API calls, translation software on the appliance generates commands to a software application on an associated user device that allows the user device to generate and display the user interface and wirelessly transmits those commands to the user device. The designer is not required to understand or do any programming of the user device, or of the wireless communications between the appliance and the user device.

According to some embodiments, disclosed herein is a method of generating a user interface on a user device, for communicating with an appliance, the method comprising: generating, by a first microcontroller in the appliance, an Application Programming Interface (API) call corresponding to a user interface object to be included in the user interface on the user device; translating, by a second microcontroller in the appliance, the API call into an application command specifying the user interface object; communicating, by a third microcontroller in the appliance, the application command to the user device using a wireless communication protocol; and generating, by a processor in the user device, the user interface including the user interface object specified by the application command.

According to other embodiments, disclosed herein is a system for generating a user interface on a user device, for communicating with an appliance, the system comprising: a first microcontroller in the appliance configured to generate an Application Programming Interface (API) call corresponding to a user interface object to be included in the user interface on the user device; a second microcontroller in the appliance configured to translate the API call into an application command specifying the user interface object; a third microcontroller in the appliance configured to communicate the application command to the user device using a wireless communication protocol; and a processor in the user device configured to generate a user interface including the user interface object specified by the application command.

According to further embodiments, disclosed herein is a non-transitory computer readable storage medium having embodied thereon instructions for causing a computing device to execute a method of generating a user interface on a user device, for communicating with an appliance, based on application programming interface (API) calls, the method comprising: receiving, from a first microcontroller in the appliance, an Application Programming Interface (API) call corresponding to a user interface object to be included in the user interface on the user device; translating, by a second microcontroller in the appliance, the API call into an application command specifying the user interface object; communicating, by a third microcontroller in the appliance, the application command to the user device using a wireless communication protocol; and generating, by a processor in the user device, the user interface including the user interface object specified by the application command.

### BRIEF DESCRIPTION OF THE DRAWINGS

FIG. 1 is a block diagram of a system including a user device and a smart plug having an embedded device according to one embodiment.

FIG. 2 is an illustration of a screenshot of a display screen of a user device with a user interface displayed according to one embodiment.

FIG. 3 is an illustration of a screenshot of a display screen of a user device with another user interface displayed according to one embodiment.

FIG. 4 is an illustration of how objects of the screenshot FIG. 2 may be spaced on a display screen according to one embodiment.

FIG. 5 illustrates the data flow between an embedded device and a user device according to one embodiment.

FIG. 6 is a flowchart of a method of generating a user interface for communicating with a remote device according to one embodiment.

### DETAILED DESCRIPTION

A system and method for generating a user interface for communicating with a remote device is described. An appliance designer selects objects from a library of available UI objects to be displayed in a user interface (“UI objects”) by making API calls. From the API calls, translation software (a form of “middleware”) on the appliance generates commands to a software application (often called an “app”) on an associated user device that allows the user device to generate and display the user interface, and wirelessly transmits those commands to the user device.

From the perspective of the designer, only selection of the UI objects by including the appropriate APIs to call those objects is required, and the resulting user interface is platform independent. The translation software and user device software, which may be provided by a party other than the designer, allow the user device to display the user interface without the designer of the appliance needing to know what user device might be used or to have to do any programming specific to any device operating system. Further, the designer of the appliance need not do any programming for the particular wireless communication protocol used to communicate with the user device.

A library of UI objects that may be used in a user interface is defined. Each UI object may be selected by a microcontroller of an embedded device making an API call corresponding to each object that is desired. The UI objects to be used in a user interface may be static, i.e., only to be displayed; or functional, such that a user may interact with them and input data or selections. The designer of an appliance having an embedded device provides a first microcontroller of the embedded device with firmware that makes API calls corresponding to the UI objects in the library that the designer wishes to appear in a user interface.

A second microcontroller translates the API calls into application commands for an application residing on the user device, and a third microcontroller wirelessly transmits the application commands to the user device. (In some instances, two or more microcontrollers may be combined into a single microcontroller or processor.) A processor in the user device runs the application that generates and displays the user interface based upon the received application commands.

This allows a designer of an appliance with an embedded device to create a user interface that can be displayed on multiple user device platforms without having to write code, or even know how to write code, for any of those platforms, or for any wireless communication protocol. The designer need only select UI objects from the library of available UI objects and write the appropriate API calls for those UI objects into the firmware of the embedded device.

As is known to those of skill in the art, the term “appliance” may include a very broad array of devices that may use embedded devices. Appliances may include, but are not limited to, household appliances and devices such as washers, dryers, refrigerators, ovens, lighting systems, security systems, “smart” electric plugs, etc., televisions and other audio/video systems, printers/copiers/fax machines, cameras, microphones, outdoor lighting and irrigation systems, and many other devices that, as above, are considered to be part of the developing Internet of Things.

API calls and how to write and use them are well known to those of skill in the art. In addition, products that allow an application to be written without knowledge of the underlying operating system by using such API calls are well known. For example, in the 1980's, Apple introduced HyperCard, an application software and programming tool for Apple Macintosh and IIGS computers. HyperCard had database and programming abilities and a user-modifiable graphical interface. However, while HyperCard did not require a user to know how to program the user interface, it was both local, running only on the computer it was installed on, and platform-dependent, as it ran only on Apple computers and was not available on other computers.

Applications for controlling embedded devices remotely, i.e., wirelessly without a physical connection, are also known. However, these applications typically require vertical integration, in that products that can display a user interface on a remote device require a specific program run by a microcontroller on the appliance that communicates with software on the remote device written by the appliance designer or maker specifically for the remote device. For example, while there are current smart plugs from individual manufacturers, these each appear to use proprietary software from the same manufacturer written specifically for each user device that must be downloaded in order for a user to access a smart plug from the user device. A designer or manufacturer of such smart plugs must thus be able to program each specific user device in question, as well as deal with ever-changing operating systems on those user devices. Embodiments of the system and method disclosed herein avoid this limitation.

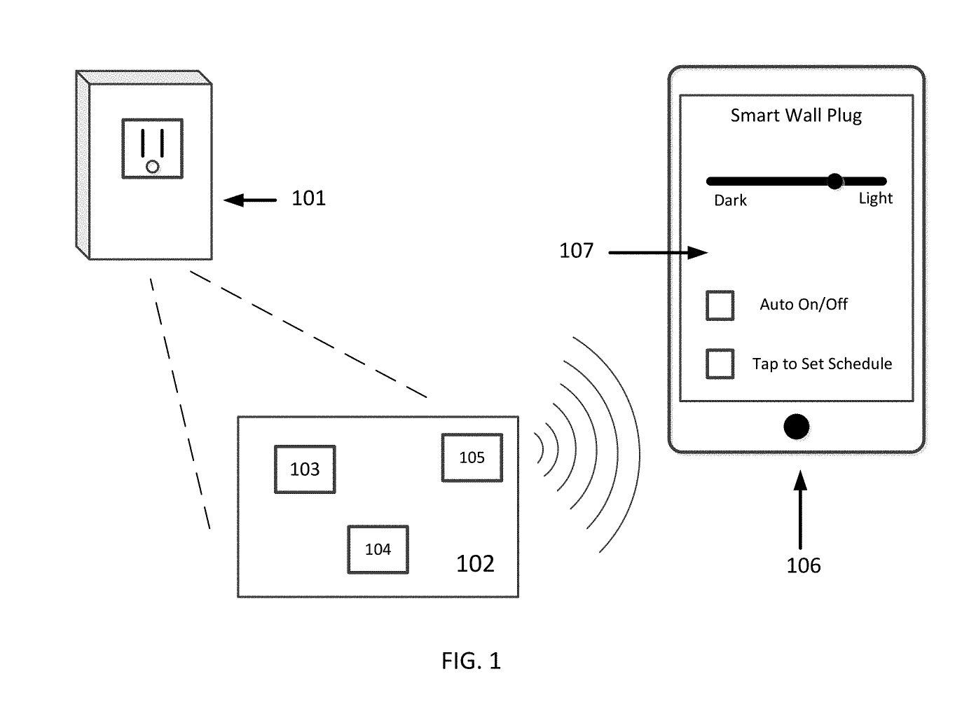

FIG. 1 is a block diagram of a system including a user device and a smart plug 101 having an embedded device according to one embodiment. The smart plug 101 includes circuit board 102 having a first microcontroller 103 that controls the operation of the smart plug 101, a second microcontroller 104 containing translation firmware (the operation of which is explained further below), and a third microcontroller 105 that is capable of wireless communication. A user device 106, such as a smartphone, tablet, computer or other device capable of wireless communication, contains a processor (not shown), software (“the application”) that interacts with the translation software (also referred to herein as translation firmware), and a display screen 107.

As above, there is a library of UI objects that may be used in a user interface, from which any given UI object may be selected by the first microcontroller 103 making an API call corresponding to that UI object. The designer of the appliance provides the first microcontroller 103 with firmware that makes API calls corresponding to the UI objects in the library that the designer wishes to appear in a user interface.

The translation firmware on second microcontroller 104 translates the API calls from first microcontroller 103 into application commands for the application residing on user device 106, and firmware on third microcontroller 105 wirelessly transmits the application commands to user device 106. (In some instances, two or more microcontrollers may be combined into a single microcontroller or processor.) The processor in user device 106 runs the application, which generates the user interface based upon the received application commands and displays it on display screen 107. Those of skill in the art, in light of the teachings herein, will easily be able to write the translation firmware for the second microcontroller 104, wireless communication firmware for the third microcontroller 105, and the application on the user device 106.

The translation firmware on second microcontroller 104 comprises middleware that allows a user interface to be generated and displayed on user device 106 without the designer of smart plug 101 or first microcontroller 102 having to write a program to create the user interface. Similarly, firmware on third microcontroller 105 transmits application commands without the designer having to understand or write software for the wireless protocol used. The designer is only required to select UI objects from the library of available UI objects and write the appropriate API calls for those UI objects into the firmware of first microcontroller 103.

As is well known to those of skill in the art, the API calls and firmware may be easily written in assembly language, C, C++, Java, or other programming languages. Various protocols well known to those in the art are also available to connect the microcontrollers, including SPI, UART, 12C, etc.

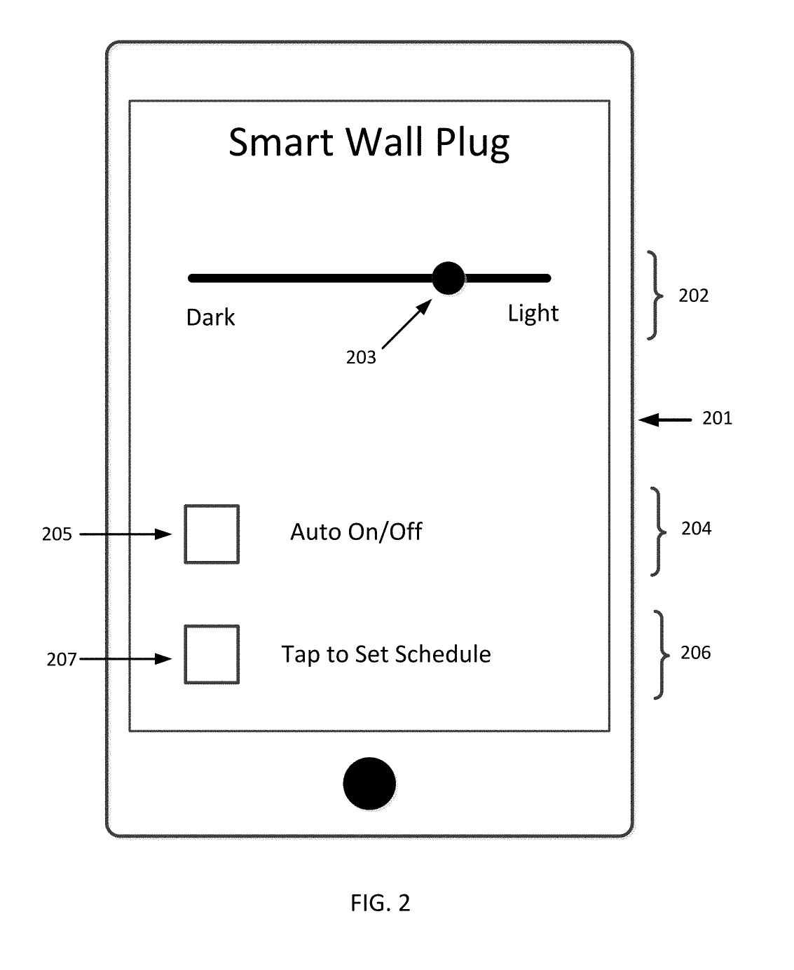

An example of a simple user interface to control the smart plug 101 of FIG. 1 may be seen in FIG. 2. FIG. 2 is an illustration of a screenshot of the display screen 201 of a user device, such as display screen 107 of user device 106 of FIG. 1, with a possible user interface displayed. In this instance, the designer of the smart plug has selected several UI objects to be part of the user interface. From the library of UI objects available, the designer has selected as a first UI object 202 a slider control for controlling the power delivered from the plug, a similar functionality to a dimmer switch, and assigned the labels “dark” and “light” to opposite ends of the slider corresponding to no power and full power, respectively. In this illustration, the slider bar is set at about 70% power as shown by the large dot 203.

The user interface also includes a second UI object 204, which is labeled “Auto On/off” and has a box or “button” 205 that may be checked, touched or clicked to indicate that the plug should automatically go on and off at certain times. Finally, the user interface includes a third UI object 206 which has a box or “button” 207 to be touched or clicked on by a user, with the label “Tap to set schedule.” (Selecting the button 207 will take the user to another screen as described below.)

As above, to create this user interface, a designer merely includes in the firmware of a microcontroller in the appliance, such as first microcontroller 103, API calls for the three UI objects 202, 204 and 206. These API calls correspond to three UI objects in the library, i.e., a UI object with a slider control, a UI object with a box or button control, and a UI object with a box or button to cause a second screen of the user interface to be displayed.

The designer does not need to program the user interface, or even know or care what type of device user device 106 is or what operating system it uses. Rather, as above, the translation firmware on second microcontroller 104 converts the API calls into commands to the application on user device 106 which are wirelessly transmitted to user device 106 and cause the processor in user device 106 to generate and display the desired user interface. Nor does the designer need to program the wireless protocol used to transmit the application commands; firmware on third microcontroller 105 handles the wireless transmission.

While only three UI objects are illustrated in FIG. 2, many more UI objects are possible. As above, UI objects may be static or functional. Static UI objects include labels, text (may be one or multiple lines of text), shapes, icons, or graphic images.

Functional UI objects can allow input from users, and may include, but are not limited to, such things as:
On/Off button
Multi-position button
+|− integer value increment and decrement
Slider
Expandable selection list for short list of a few items
“Picker” for a longer list of items
Number selector to select a number in a range
Time selector
Calendar date selector
Multiple selection
Checkboxes
Radio Buttons
Text entry box
Number-only entry box
An icon/graphic denoting a “tappable” area

Functional UI objects can also provide output to users, which may include, but are not limited to, such things as:
Text box
Progress bar
Progress circle
Vertical gauge
Horizontal gauge
Semicircular gauge
Circular gauge
RGB LED
Battery level indicator
Audible beeps

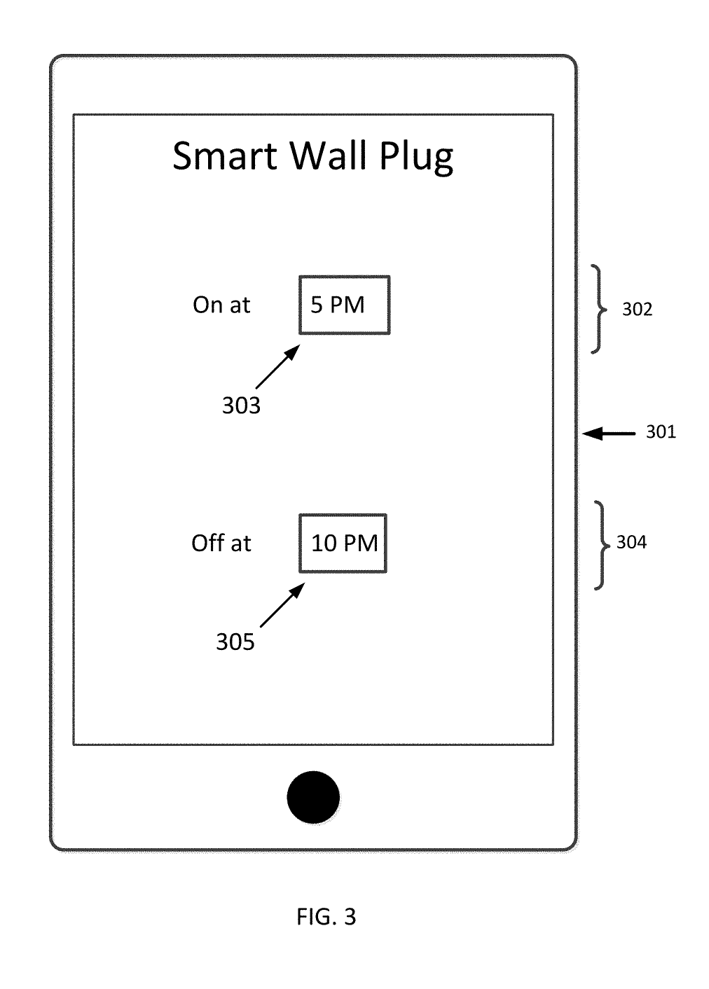

The user interface may include multiple screens. For example, if the user taps the button in the third UI object 206 of FIG. 2, the user may be presented with a screen such as is illustrated in FIG. 3. Screen 301 contains two UI objects, a first UI object 302, with a label “On at” and a box 303, and a second UI object 304 with a label “Off at” and a box 305. The boxes 303 and 305 allow the user to enter times when the plug is to turn on and off, respectively.

In some embodiments, the user will use a keyboard on the user device 106 to enter these times. (In the case of a smartphone as illustrated, or a tablet, the keyboard may be a “virtual” one displayed by the user device when the user taps on box 303 or 305.) In other embodiments the user may be presented with a pull down menu in each UI object from which to select the times. In still other embodiments, there may be multiple pull down menus in each UI object, one for hours, one for minutes, and one for a.m. or p.m. There will also typically be a “return” or “exit” button or arrow (not shown) on screen 301 to return to the screen 201 of FIG. 2.

Again, the designer of the smart plug 101 need not write an application for the user device 106 to provide the user interface, or even know how to write such an application of how to program the user device 106. Rather, as above, the designer need only select the three desired UI objects 202, 204 and 206 that the designer wishes to appear on screen 201, and the two desired UI objects 302 and 304 that are desired for screen 301 from the library of available UI objects.

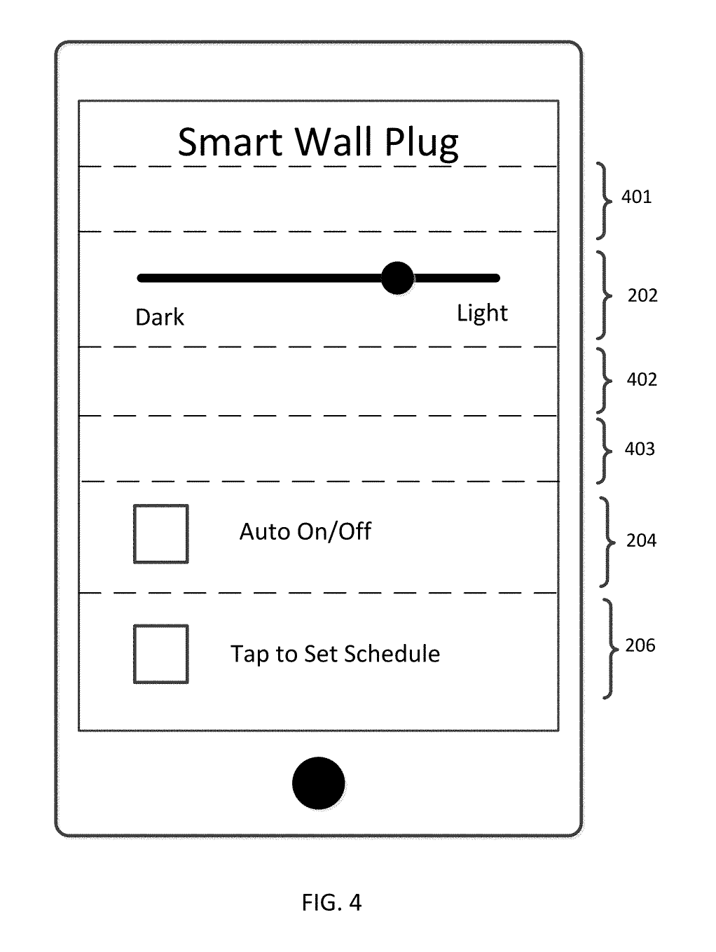

FIG. 4 is an illustration of how the three UI objects 202, 204 and 206 of FIG. 2 may be spaced on display screen 107. Additional “blank” or “spacer” UI objects 401, 402 and 403 are included to cause UI objects 202, 204 and 206 to be located on display screen 107 in an aesthetically pleasing way. This will be explained further below.

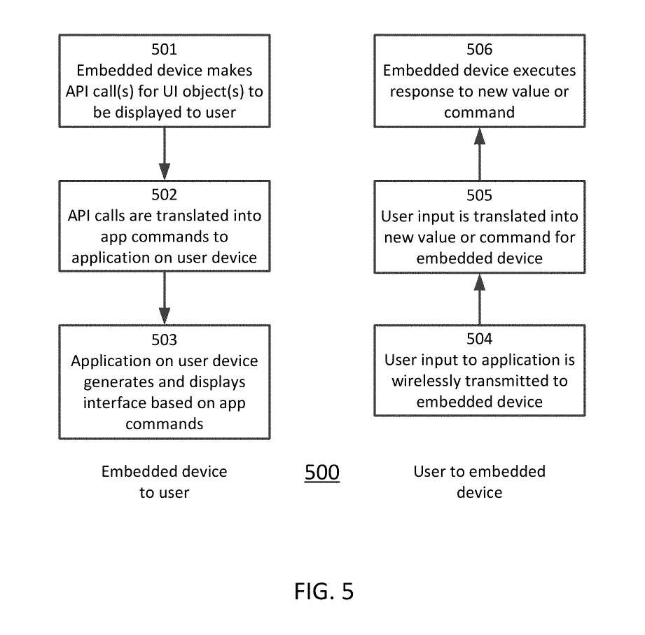

FIG. 5 illustrates the data flow 500 between the embedded device, such as that contained in smart plug 101 of FIG. 1, and the user device, such as user device 106. At step 501, API calls for selected UI objects from a library of available UI objects are made, the selected UI objects being those that are desired to appear in a user interface for the appliance, such as smart plug 101 in the example herein, that contains the embedded device. In this example, this is done by microcontroller 102 based upon the firmware in microcontroller 102. The designer of the smart plug 101 will write the firmware to make the appropriate API calls for the desired UI objects.

At step 502, the API calls from microcontroller 102 are translated, in the example herein by microcontroller 103, into application commands for an application residing on the user device, here user device 106. These application commands are then sent wirelessly by microcontroller 104 to user device 106, where, at step 503, a processor in user device 106 running the application generates and displays a user interface based upon the application commands.

When a user wishes to respond to, or direct some action by, the embedded device, data flows in the opposite direction. Once a user has entered on user device 106 some new value or indication of a desired command to the embedded device, at step 504 the application on user device 106 transmits the user's input to the appliance containing the embedded device, where it is received by, for example, third microcontroller 105.

At step 505, the user input is translated, for example by second microcontroller 104, into a new value or command for the embedded device that can be understood by first microcontroller 103. At step 506, first microcontroller 103 causes the embedded device to take an appropriate action in response to the new value or command from the user.

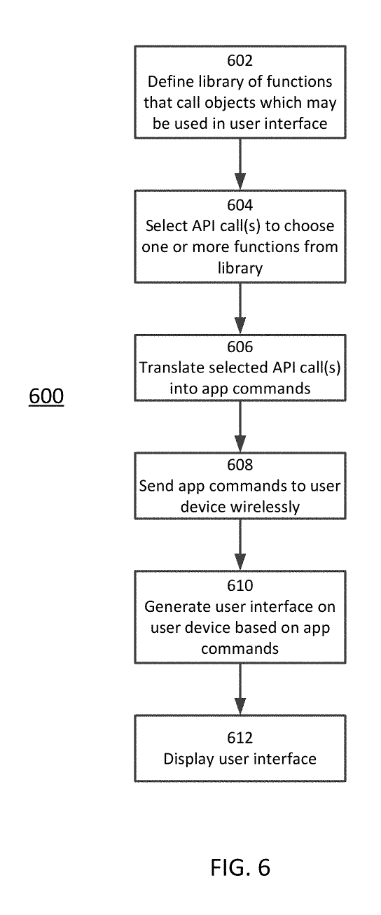

FIG. 6 is a flowchart of a method 600 of generating a user interface for communicating wirelessly with an appliance according to one embodiment.

At step 602 a library of UI objects that may be used in a user interface is defined. As above, UI objects that are desired may be selected by a microcontroller of an embedded device making an API call corresponding to each such UI object.

At step 604, a first microcontroller of an embedded device in an appliance selects API calls to choose one or more UI objects from the library. A designer of the appliance will have provided the first microcontroller with firmware that makes the API calls corresponding to the UI objects in the library that the designer wishes to appear in a user interface.

At step 606, a second microcontroller translates the API calls into application commands for an application residing on a user device. A third microcontroller then wirelessly transmits the application commands to the user device at step 608.

At step 610, a processor in the user device runs the application that generates the user interface based upon the received application commands, and then, at step 612, displays the user interface to the user on a display screen in the user device.

As will be apparent, different devices have different screen sizes and different numbers of pixels in their displays. Smartphones, tablets and computers are all available with different screen sizes, and in some cases different orientations, i.e., laptops generally have a display that is wider than high, while smartphones and tablets are normally higher than wide, but in many environments have an interface that rotates and adjusts when the device is turned.

If only a single layout of a user interface is implemented, the user interface may look significantly different on different devices. While each operating system may provide some adjustment, this will generally not solve the problem. For example, an iOS application running on, or a user interface displayed on, an iPhone may look “squashed” on an iPad, due to the difference in the height to width ratio of the two devices. Further, iOS will provide different solutions than Android or other operating systems.

Thus, in prior art applications that are written specifically for each device, to make the user interface look similar from one device to another, an appliance designer may take the screen size and number of available pixels into account in creating a user interface for each possible device. Thus, the appliance designer must adapt the user interface for the number of available pixels on each device, and may want or need to allow for rotation of the device as well.

The described method and system may assist with this problem as well. In addition to allowing a designer of an appliance to use API calls to select UI objects for display on any device, the described method easily allows a user interface to appear approximately the same on devices having different screen sizes.

This is illustrated in FIG. 4. In the example above, the first screen of the desired user interface has the three UI objects 202, 204 and 206 as shown in FIGS. 2 and 4. In some embodiments, all of the UI objects have a default width of 320 pixels, which is expected to be the narrowest screen size on which the user interface will be displayed. If the display screen on a device is wider than 320 pixels, the UI objects are scaled to the pixel width of the actual display on the device by the application on the device that generates the user interface from the application commands.

Each UI object also has a defined height in pixels. If all of the UI objects in a selected user interface cannot fit vertically on a particular screen, the user interface may be scrollable by a standard method, such as swiping up and down on a touch screen, or using arrow keys on a computer.

In other cases, where it is expected that the user interface will not occupy the entire screen, such as that in FIGS. 2 and 4, the appliance designer may anticipate the need to adjust the overall height of the user interface to maintain a pleasing perspective. This may be accomplished by adding additional “blank” UI objects, either between a selected UI object and the top or bottom of the screen, or between UI objects in the user interface. Here blank UI objects 401, 402 and 403 are added; blank UI object 401 is between UI object 202 and the top of the screen, while blank UI objects 402 and 403 are between UI objects 202 and 204.

In addition, blank UI objects 401, 402 and 403 may be automatically adjusted to “auto-balance” the user interface, i.e., maintain a relatively uniform spacing between the UI objects 202, 204 and 206 of the user interface across various platforms. As above, the UI objects 202, 204 and 206 will typically have specified numbers of pixels. To accomplish auto-balancing, the application on the user device can divide the number of pixels on the display screen not occupied by UI objects 202, 204 and 206, by the number of blank UI objects selected by the designer (here 3), and cause each blank object to occupy a pro rata portion of the otherwise unused pixels.

Thus, in FIG. 4, such auto-balancing will result in each blank UI object 401, 402 and 403 occupying one-third of the display pixels in the vertical direction that are not used by UI objects 202, 204 and 206. This will, of course, be a different number of pixels on different devices, but will result in the user interface appearing to have relatively the same layout on different devices.

Various other enhancements to the disclosed method and apparatus will be apparent to one of skill in the art in light of the teachings herein. For example, it will be appreciated that it will be beneficial to have some memory in the appliance that stores any settings that have been input from a user device so that the appliance not only operates according to those settings until they are changed, but also, if the user should access the appliance from a different user device than the one from which the settings were made, those settings may be displayed to the user through the user interface on the additional device.

In some embodiments the embedded device(s) in the appliance may generate data that is desirable to store in a third location (i.e., a location other than the appliance or the user device, for example, over the Internet) for later processing or analysis. For example, a manufacturer may wish to collect data from all of the installed appliances of a particular type to track reliability, performance, etc. An API may be provided for passing such information to such a third location, or to the user device with an indication that the information is to be uploaded to the third location, for example, over the Internet.

Another possible feature is that application commands may be cached in the application on the user device to be run when the application is launched on the user device. Those application commands can be cached in the application on the user device either after receiving them for the first time or be included in the application as an initial state when the application is loaded onto the user device. Caching application commands on the user device allows the application to run nearly as fast as a “native” app that is customized for a particular user device, as the time to transfer commands wirelessly from the appliance is all or mostly eliminated. A basic caching scheme would cache most or all of the commands that the user interface application might receive for any appliance and/or user device after the commands are transferred once by the embedded device, while a customized caching scheme would cache commands that might be received by a user interface application customized to a specific appliance and user device directly as part of the customized UI application, eliminating any transfer overhead.

A generated user interface may contain certain items to be displayed in the user interface, or actions to be taken, in response to a user input, that are performed by the application on the user device without transmission of data or commands between the user device and the appliance, saving lag time between the user action. For example, in some cases a user may tap on a box or button that simply calls for the display of a second screen to the user. The second screen may be denoted on the user device as a “linked UI object” using an API so that the user device need not send data back to the appliance, and the appliance need not send application commands back to user device to display the second screen.

Thus, as above on FIGS. 2 and 4, tapping the box or button 207 next to “Tap to see schedule” in UI object 206 takes the user to the display screen 301 seen in FIG. 3, where times may be entered to turn the smart plug on and off. Such operations on display screen 301 may similarly be performed in the application on user device 107 so that user device 107 need not send data back to the appliance in response to a tap by the user on box 207, and the appliance need not send application commands back to user device 107 to display screen 301 (although it may be desirable for the appliance to send back the data that appears in boxes 303 and 305 of screen 301).

Similar and other enhancements will be apparent to those of skill in the art in light of the teachings herein.

The disclosed method and apparatus has been explained above with reference to several embodiments. Other embodiments will be apparent to those skilled in the art in light of this disclosure. Certain aspects of the described method and apparatus may readily be implemented using configurations or process steps other than those described in the embodiments above, or in conjunction with elements other than those described above.

For example, wireless communication between the appliance and the user device may be made using Bluetooth or other short range wireless communications protocols such as near field communications (NFC) or wireless local-area network (WLAN) protocols such as WiFi or wireless USB. In some instances, it may even be appropriate to use a longer range communications protocol, such as a cellular or satellite communication protocol. One of skill in the art will understand the advantages of each wireless protocol and will be able to select an appropriate protocol for a given situation.

It should also be appreciated that the described method and apparatus can be implemented in numerous ways, including as a process, an apparatus, or a system.

While three microcontrollers are described herein, in some embodiments two, or even all three microcontrollers, may be part of a single microcontroller. The user device may be a smartphone, tablet, laptop computer, desktop computer, or any other device that may run an appropriate application to receive application commands from the appliance.

The methods described herein may be implemented by program instructions for instructing one or more processors or microcontrollers to perform such methods, and such instructions recorded on a computer readable storage medium such as a hard disk drive, floppy disk, optical disc such as a compact disc (CD) or digital versatile disc (DVD), flash memory, etc., or via a computer network wherein the program instructions are sent over optical or electronic communication links. Such program instructions may be executed by means of one or more processors or microcontrollers, or in some embodiments may even be incorporated into fixed logic elements.

These and other variations upon the embodiments are intended to be covered by the present disclosure, which is limited only by the appended claims.

What is claimed is:

1. A method of generating a user interface on a user device, for communicating with an appliance, the method comprising:
generating, by a first microcontroller in the appliance, an Application Programming Interface (API) call corresponding to a user interface object to be included in the user interface on the user device;
translating, by a second microcontroller in the appliance, the API call into an application command specifying the user interface object;
communicating, by a third microcontroller in the appliance, the application command to the user device using a wireless communication protocol; and
generating, by a processor in the user device, the user interface including the user interface object specified by the application command.

2. The method of claim 1 further comprising displaying, by the processor in the user device, the user interface including the user interface object specified by the application command on a screen in the user device.

3. The method of claim 1 further comprising, before generating the API call, storing in a memory in the appliance a library of API calls corresponding to user interface objects.

4. The method of claim 1 wherein the first microcontroller and the second microcontroller are the same microcontroller.

5. The method of claim 1 wherein the second microcontroller and the third microcontroller are the same microcontroller.

6. The method of claim 1 wherein the first microcontroller, the second microcontroller and the third microcontroller are the same microcontroller.

7. The method of claim 1 wherein the wireless communication protocol is a Bluetooth protocol.

8. The method of claim 1 wherein the wireless communication protocol is a WiFi protocol.

9. The method of claim 1 wherein the wireless communication protocol is a wireless USB protocol.

10. A system for generating a user interface on a user device, for communicating with an appliance, the system comprising:
a first microcontroller in the appliance configured to generate an Application Programming Interface (API) call corresponding to a user interface object to be included in the user interface on the user device;
a second microcontroller in the appliance configured to translate the API call into an application command specifying the user interface object;
a third microcontroller in the appliance configured to communicate the application command to the user device using a wireless communication protocol; and
a processor in the user device configured to generate a user interface including the user interface object specified by the application command.

11. The system of claim 10 wherein the processor in the user device is further configured to display the user interface including the user interface object specified by the application command on a screen in the user device.

12. The system of claim 10 further comprising a memory in the appliance configured to store a library of API calls corresponding to user interface objects.

13. The system of claim 10 wherein the first microcontroller and the second microcontroller are the same microcontroller.

14. The system of claim 10 wherein the second microcontroller and the third microcontroller are the same microcontroller.

15. The system of claim 10 wherein the first microcontroller, the second microcontroller and the third microcontroller are the same microcontroller.

16. The system of claim 10 wherein the wireless communication protocol is a Bluetooth protocol.

17. The system of claim 10 wherein the wireless communication protocol is a WiFi protocol.

18. The system of claim 10 wherein the wireless communication protocol is a wireless USB protocol.

19. A non-transitory computer readable storage medium having embodied thereon instructions for causing a computing device to execute a method of generating a user interface on a user device, for communicating with an appliance, based on application programming interface (API) calls, the method comprising:
receiving, from a first microcontroller in the appliance, an Application Programming Interface (API) call corresponding to a user interface object to be included in the user interface on the user device;
translating, by a second microcontroller in the appliance, the API call into an application command specifying the user interface object;
communicating, by a third microcontroller in the appliance, the application command to the user device using a wireless communication protocol; and
generating, by a processor in the user device, the user interface including the user interface object specified by the application command.
